(19) United States
(12) Patent Application Publication
(10) Pub. No.: US 2016/0107552 A1
(43) Pub. Date: Apr. 21, 2016

(54) MULTI-FUNCTION CUSTOMIZABLE COVER

(71) Applicant: Olivia Wakeman, Austin, TX (US)

(72) Inventor: Olivia Wakeman, Austin, TX (US)

(21) Appl. No.: 14/842,604

(22) Filed: Sep. 1, 2015

Related U.S. Application Data
(60) Provisional application No. 62/044,686, filed on Sep. 2, 2014.

(51) Int. Cl. B60N 2/60; A47C 31/10; B63B 29/04; B60N 2/38

(52) U.S. Cl. CPC B60N 2/6054; B60N 2/38; A47C 31/10; B63B 29/04; B63B 2029/043

(57) ABSTRACT

The present disclosure incorporates a system, apparatus and method, which is customizable by a user to meet their specific needs relating to the coverage, protection, and application. Exemplary application of the present disclosure include pet, transportation, baby & child, home, garden, security, military, medical/health, camping/outdoor, promotional products, communications, electronics, entertainment, food & beverage, general merchandise, construction, relief efforts and more.

### FIELD OF THE INVENTION

This disclosure relates to covers and tarpaulins. Specifically, to covers and tarpaulins that can be customized by the user.

### BRIEF DESCRIPTION OF THE INVENTION

Covers and tarpaulins exist in various forms, but that none are specifically designed such that they may be customized by cutting, piercing or similarly altered by the end user.

Whether for a car, truck, boat, couch, tractor cab or other location, seat covers are generally used for three purposes: to protect a seat from damage, to cover the existing damage of a seat, or to decorate or otherwise improve a seat.

Vehicle owners commonly use seat covers to protect seats from damage caused by pets, child seats, children and other cargo. If the seat has already been damaged, the vehicle owner may want to prevent further damage or to have an aesthetically pleasing seat cover over the damaged seat. Vehicle owners may also desire a seat cover for purely aesthetic reasons.

Generally, seat covers on the market fall into one of two categories: generic/one-size-fits-all and custom seat covers. The generic seat covers typically consist of either a single sheet of fabric that covers the seat or there are two sheets of fabric, with one sheet covering the seat back, and one sheet applied to the seat bottom.

In the case of single-sheet generic seat covers, the seat cover may have features to secure the seat cover to one or more headrests or the back window shelf. More commonly, a portion of the seat cover is tucked between the seat back and the seat bottom, and any excess on the sides is tucked behind the seat, or is left unattached and unsecured. Unfortunately for the vehicle owner, this type of seat cover usually has pre-cut holes for all of the vehicle's seat belts and other connectors. These holes are generally fairly large to accommodate a range of vehicles and allow debris between the seats.

Seat covers comprised of two sheets of fabric have some benefits over single-sheet seat covers in that the seatbelts in most vehicles will not be obstructed by the two sheet seat covers. However, if a child spills a drink, or a pet drops hair or dirt or has an accident, the two-sheet seat covers are undesirable because the seat cover does not retain the liquid or loose particles. Depending on the liquid or particles, there can be permanent stains and smells associated with the seat.

One solution to date has been the development of custom seat covers. Custom seat covers are generally manufactured for a specific make, model and year of vehicle or for a particular type of seat (e.g. a bucket seat or a bench seat). In the first instance, the vehicle owner tells the seat cover manufacturer the make and model of the vehicle, and the seat cover manufacturer manufactures the seat cover to the seat specifications. A benefit to this type of seat cover is that the seat cover has pre-cut openings for seat belts and other features on the specific vehicle and the seat cover usually has features to enable the owner to secure the seat cover to the seat. Disadvantages of this type of seat cover include the high cost associated with manufacturing a custom seat cover and the level of expertise required to install certain custom seat covers and, often, the gap which still allows debris to enter the crevice between the back and bench.

Current covers are customized by the manufacturer, wholesaler or retailer and too often don't address the individual needs of the user. For example, automotive covers to protect the backseats of cars from dog or child debris are currently made with areas already removed for seatbelts, shoulder harnesses, etc. If the only being transported is a dog or one child, many of these built-in openings are unnecessary and allow less protection for the vehicle. This, in turn, affects the underlying cleanliness and, eventually, the possible resale value of the car. Many current covers are also difficult to install and may be difficult to clean. In addition, vehicle owners—car, truck, RV, boat, etc.—may want a cover that they can quickly toss over a seat, cargo area or other area to protect the area from people in wet bathing suits or from other annoying or destructive forces.

Tarpaulins currently available are not designed to enable an end user to customize. They are pre-customized by the wholesaler or retailer and often do not address the specific needs of the user. One solution to date is for an end user to attempt to customize existing tarpaulins which are not designed for that purpose. This often results in compromising the design and/or integrity of the object. Such activities may result in irregular edges or shapes which do not effectively cover or contain the desired object(s). Additional damage may be done to the original structure of existing tarpaulins by the end user removing existing reinforcements in such forms as rivets, buckles, tie-downs and other objects that have been integrated into the tarpaulin by the wholesaler or retailer.

The present disclosure describes a multi-function use cover and tarpaulin that may be constructed from a material or assembly of materials. For the purposes of the present disclosure, the term cover is intended to include a cover, a tarpaulin, or some combination thereof. The material(s) may be cut, pierced or otherwise affected by the end user, whereby (a) the end user may adapt the item to his/her/their specific need(s), (b) the end user may attach the item according to his/her/their specific need(s) or may employ it unattached; (c) the materials may in part or whole be constructed of material(s) that are resistant to unintentional unraveling, tearing and/or puncture. The Cover may be used with and/or contain liquids, solids, gases, animate and/or inanimate bodies and or other items or substances and/or elements and/or any combination thereof.

One feature of the present disclosure offers a unique form of design and utility. Embodiments may be constructed of any functional material(s) that can be cut, pierced and/or similarly altered by the end user.

A further feature of some embodiments of the present disclosure is to provide protection and/or aesthetic improvement and/or to adapt to end user-specific needs.

A further feature of some embodiments enables the customization of the Cover by end user to meet specific needs.

A further feature of some embodiments is the provision of a customization guide. A further feature assists users with altering the Cover.

A further feature of some embodiments is the provision of maximum coverage by permitting penetration of the cover only in desired locations.

One embodiment of the present disclosure is directed to a seat cover adapted for customization to meet the desired purpose, and to secure the cover to a seat.

A further embodiment of the present disclosure is directed to a multi-use tarpaulin capable of being modified to customize a tarpaulin for a desired purpose.

Some embodiments of the present disclosure may be constructed of various materials. One embodiment comprises a vinyl front and a polyester flannel reverse, and can be secured to backseat headrests with hook-and-loop strips. In this embodiment, the flannel reverse provides the added benefit of not chafing leather seats and still allowing them to breathe.

Some embodiments may not contain a customization guide.

A further embodiment incorporates hook-and-loop fasteners attached to the cover or used with the cover reinforced with fabric-based or pressure-sensitive adhesive tape to stabilize, attach and prevent stretching and/or tearing.

A further embodiment incorporates an additional cloth layer to provide further reinforce against undesired puncture, tearing or other damage, while still being easily customized.

A further embodiment is configured with a layer of polyvinyl chloride or other waterproof material to provide a waterproof layer/property.

A further embodiment is then glued to a second layer or merged with a second layer, which may be constructed of polyester or other material or coating to provide a non-abrasive or an abrasive layer.

A further embodiment is configured with a polyester layer, which can be ink-printed with a customization grid of 1-inch squares.

A further embodiment may be configured with one end reinforced using two rows of argyle pattern stitching; machine stitched using 2-ply waxed nylon thread. Some embodiments use stitching, coating, additional layers, embedded elements and/or other methods of reinforcement. Some embodiments may have rows of argyle pattern, overlapping loop or other stitching. Some embodiments may be machine stitched.

A further embodiment incorporates a PVC face and a polyester backing and non-slip or slip resistance properties.

The customizable multi-use cover may comprise a protective cover having a front, back and upwardly and facingly disposed sides, one or more pliable layers comprised of a pliable material. Portions of the sides may be removed to adapt and conform the cover to fit over an object. First openings may be cut through the cover to removably attach the cover to a vehicle headrest, and second openings may be cut through the cover to accommodate a seat belt buckle. The object may be selected from the group consisting of automobiles, boats, recreational vehicles, all-terrain vehicles, lawn mowers and mechanical equipment. The upwardly and facingly disposed sides may further comprise a customization guide to provide an end user with guidance on customizing the cover to fit the object. The pliable material may comprise a material that is resistant to tearing, puncturing, injury and destruction and may be waterproof. One of the sides may be formed from a material with non-slip properties. The customizable multi-use cover may be customizable by an end user. The cover may be in a kit form whereby portions of the sides are able to be removed by an end user to adapt and conform the cover to fit over an object, first openings are able to be cut through the cover to removably attach the cover to a vehicle headrest, and whereby second openings are able to be cut through the cover accommodate a seat belt buckle. The cover may be customizable by an end user by removing portions of the sides to removably adapt and conform the cover to fit a vehicle seat, by cutting first openings through the cover to removably attach the cover to vehicle headrests and by cutting second openings through the cover to accommodate a seat belt restraints.

### BRIEF DESCRIPTION OF THE DRAWINGS

The novel features believed characteristic of the disclosed subject matter will be set forth in any claims that are filed later. The disclosed subject matter itself, however, as well as a preferred mode of use, further objectives, and advantages thereof, will best be understood by reference to the following detailed description of an illustrative embodiment when read in conjunction with the accompanying drawings, wherein:

FIG. 1 illustrates an aerial perspective of an exemplary cover.

FIG. 2 illustrates an exemplary multi-layered configured embodiment.

FIG. 3 illustrates an exemplary embodiment of the present disclosure in use as a car seat cover.

### DESCRIPTION OF ILLUSTRATIVE EMBODIMENTS

Before describing selected embodiments of the present disclosure in detail, it is to be understood that the present disclosure is not limited to the particular embodiments described herein. The disclosure and description herein is illustrative and explanatory of one or more presently preferred embodiments of the disclosure and variations thereof, and it will be appreciated by those skilled in the art that various changes in the design, organization, order of operation, means of operation, equipment structures and location, methodology, and use of mechanical equivalents may be made without departing from the spirit of the disclosure.

As well, it should be understood the drawings are intended illustrate and plainly disclose presently preferred embodiments of the disclosure to one of skill in the art, but are not intended to be manufacturing level drawings or renditions of final products and may include simplified conceptual views as desired for easier and quicker understanding or explanation of the disclosure. As well, the relative size and arrangement of the components may differ from that shown and still operate within the spirit of the disclosure as described throughout the present application.

Moreover, it will be understood that various directions such as “upper”, “lower”, “bottom”, “top”, “left”, “right”, and so forth are made only with respect to explanation in conjunction with the drawings, and that the components may be oriented differently, for instance, during transportation and manufacturing as well as operation. Because many varying and different embodiments may be made within the scope of the inventive concept(s) herein taught, and because many modifications may be made in the embodiments described herein, it is to be understood that the details herein are to be interpreted as illustrative and non-limiting.

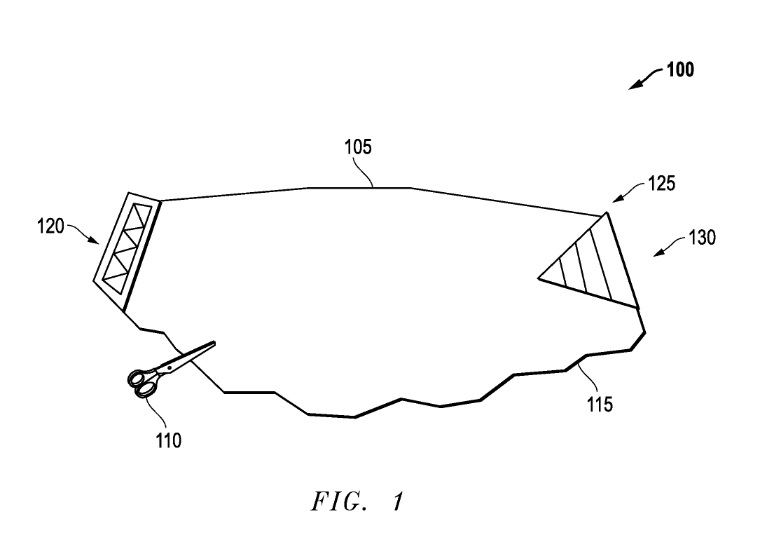

FIG. 1 illustrates an aerial perspective view of an embodiment of the Cover 105. It presents one configuration of the Cover 105 including designated example options. Elements of the illustrated embodiment include:
(i.) the Cover material of the Cover 105 may be any shape or size that is possible within the parameters of this disclosure;
(ii.) may be cut, pierced or otherwise 110 affected such as, but not limited to, with scissors;
(iii.) may be resistant to unraveling, tearing and/or unintentional puncture 115;
(iv.) may be used with and/or contain liquids, solids, gasses, animate and/or inanimate bodies and or other items or substances and/or elements and/or any combination thereof.

This figure also illustrates optional features and/or attributes, including:
(i.) a reinforcement example (detailed on the left end of the FIG. 120;
(ii.) is designated as waterproof or water resistant and/or non-abrasive on one or more sides 125;
(iii.) has one edge flipped over to reveal an example customization assistance guide which may be in grid form on the reverse side 130.
   Note that the cover may be a pliable cover laid flat with one starburst-like graphic to symbolize pliability

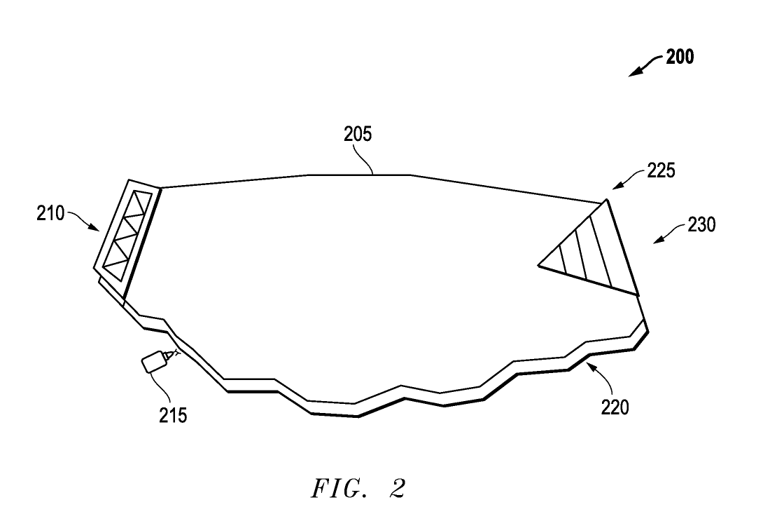

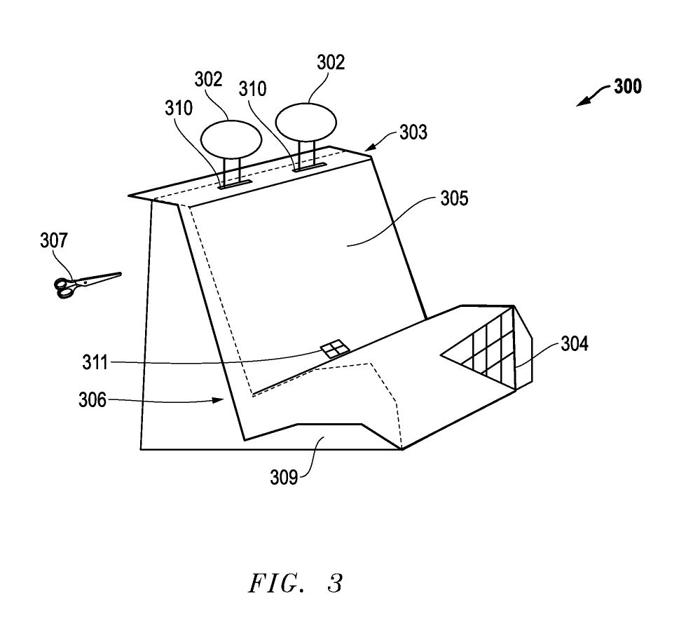

FIG. 2 200 illustrates the use and design for a further embodiment of the Cover 205. In embodiment portrayed, the Cover 205 may be used with or without any functional fastener. This specific embodiment requires no fasteners and/or other accessories. Customizations of this embodiment can be made using scissors, and other cutting instruments, to allow for:
(i.) attachment to automobile headrests as shown in FIG. 3;
(ii.) allow passage for seat belt buckle as shown in FIG. 3, 311; and
(iii.) Cover size is customized 307 to fit seat 306 as shown in FIG. 3, 309.
   The Cover 205 may be reinforced 210. It may comprise one or more layers that may be fused together 215. One or more of layers 215, including without limitation, the outer layer may be made of a non-abrasive material 220. One or more of layers 215, including without limitation, the outer layer may be made of a waterproof material 225.

A further embodiment incorporates a customization assistance guide printed on the reverse side 230. A further embodiment incorporates a reinforcement strip 210 placed on and/or incorporated into the Cover. In a further embodiment, the reinforcement location coincides with the placement of car headrest openings as shown in FIG. 3. Some embodiments of the present disclosure may be used in any way consistent with a cover and/or tarpaulin. Some embodiments may be used to cover, contain, protect, and/or to provide other such dynamics.

One embodiment is designed such that the cover slips directly over the automotive headrest(s) using no other means of attachment in the headrest area.

One embodiment contains areas that are not intended to be customized. Some exemplary embodiments may have a pre-customized area to facilitate slipping the cover directly over automotive headrest(s). Some exemplary examples have a continuous interlocking loop design comprised of elasticized cords or other pliable material in one or more places to allow user to select a pre-defined area through which to slip a headrest. Some exemplary embodiments have pliable mesh in one or more places.

One embodiment of the present disclosure is configured to protect the backseat of an automotive vehicle from debris accumulation associated with the transport of a pet, child and/or cargo. Some embodiments provide a means for the safe transport of a pet by being configured to receive safety pet harnesses and/or crates, while helping to protect the remainder of the vehicle, including crevices, seatbelts, etc. from hair, dirt, water and other unwanted substances. Some further embodiments may also be configured to protect the seat from scratches, abrasion or other damage caused by a crate and/or pet and/or other actions and/or substances.

FIG. 3 300 shows an embodiment of the Cover 305 incorporating:
(i.) two openings 310 cut into one end of the cover to allow cover to slip over the attachment area 310 rear seat headrests 302;
(ii.) opening cut 307 in area of cover that lays across the crevice between the bench and back portions of the seat to allow access through the opening 311 to one seat belt buckle;
(iii.) excess material cut from sides of cover to customize 309 fit to specific vehicle.

This embodiment allows access 311 to one seat belt buckle while preventing debris from slipping between the bench and back of the seat. Furthermore, the embodiment can be waterproof on one side and non-abrasive on the other. Furthermore, the embodiment can incorporate a grid formation customization guide 304 on the underside with grid squares in one-inch increments.

Another automotive application of some embodiments of the present disclosure includes the placement (of an embodiment) under a protective child carrier, exposing only the seatbelt(s) 311 required to secure the child seat while helping protect the remainder of the car from food, drinks, pacifiers and other interesting items that may be tossed about by the child, as well as from abrasion that may be caused by the protective seat.

A further application of embodiments includes do-it-yourself project in a room with a column or unevenly designed wall(s). The customization of embodiments enables effective protection of only the necessary area while leaving the work areas exposed. Further embodiments may also incorporate a customization guide for enabling convenient measurement and customization of embodiments to avoid gaps, wrinkles and/or puckers. In a further embodiment, the cover is waterproof and has a customization guide on the reverse side 304. This customization guide could be a grid in one-inch increments to facilitate precise measurement. Some embodiments are configured as a satisfactorily weighted material, to prevent tearing, or shifting under foot traffic. Further embodiments may have non-skid nibs on the underside to provide further stabilization.

Other embodiments of this disclosure may include but are not limited to the following. Note that the intended disclosure when describing the inclusion of a feature or function also includes the exclusion of the feature or function. Embodiments of the present disclosure may be configured to contain, withstand, provide a non-permanent barrier for solids, liquids, gases, animate or inanimate bodies or substances, and/or other items, substances and/or elements, or any combination thereof.

Embodiments of the present disclosure may be configured to allow a user to modify the item to suit his/her/their individual needs. Exemplary application of embodiment of the present disclosure include, but are not limited to:
(i.) Removing portions to accommodate one or more seat belt buckles FIG. 3, 311, such as for child seats or pet harnesses, while leaving the remainder of the cover intact to provide optimal coverage.
(ii.) Cutting, piercing, removing portion(s) or otherwise affecting 309 Cover to conform item to fit a desired space and/or shape. For example, a painter may need to paint an oddly shaped room and require a protective floor covering that conforms to the irregular space.
(iii.) Cutting areas 310 to attach cover to automotive head rest(s) 302.
(iv.) Removing areas 307 to allow for use with hooks, ties and/or other functional and/or decorative accessories.
(v.) Cutting Cover such that it provides satisfactory coverage and/or protection for a motorcycle of any shape or size, allowing for further customization for attachment, securing and/or security hardware and/or materials.
(vi.) Adjusting size and/or shape of cover for use with boats, RVs, ATVs, lawn mowers, gardening tools, or other equipment, mechanical or otherwise.
(vii.) Customizing to cover furniture to protect from animal-related, child-related or other debris. Further customizing for attachment/securing of the Cover.

Some embodiments may be configured to enable size adjustment, shape adjustment. Further embodiments may be configured to enable the removal of small or large areas and/or any other adjustment desired by the user.

Some embodiments may include in-part or in-whole, on, and or through the material a customization assistance guide(s). Further embodiments may incorporate a customization guide which may be a grid in one-inch increments printed or otherwise provided on the back side FIG. 1, 125. A further embodiment may incorporate a pattern of concentric circles FIG. 1, 130 to guide in customization for round objects. A further embodiment may incorporate a starburst pattern radiating from the center to the edges to guide in placement of holes of equal distance. A further embodiment may incorporate a pattern of concentric circles and a starburst pattern radiating from the center to the edges. This pattern may guide user with customizing Cover into a specific round size with guidance for placement of tie-down holes. Some embodiments have various other relevant shaped customization guide(s) provided for intended uses. Some exemplary embodiments provide customization guides to fit items with a specific shape in varying sizes. Some exemplary embodiments may have a random and/or camouflage pattern designed to allow soldiers or others to customize “random” areas for use in the field.

Some embodiments may be used in-tact without customization.

Some embodiments may be partly or completely constructed of material(s) that are resistant to unintentional unraveling, tearing, puncture and/or any other form of degradation, injury and/or destruction.

Some exemplary embodiments are constructed in part or whole of fine metal and/or composite mesh. Some exemplary mesh embodiments may have a customization guide(s) to allow user to customize for specific building, scientific or other purposes.

Some embodiments may partly or completely incorporate locations that are biodegradable, recyclable, designed to self-destruct, and/or be destroyed in some other manner.

Some embodiments may partly or completely incorporate locations that are configured to be manually customizable by end user with tools, such as, but not limited to, scissors or a razor knife.

Some embodiments may partly or completely incorporate locations that are configured for mechanical customization with tools, such as, but not limited to, drills, saws, and punches.

Some embodiments may partly or completely incorporate locations that are pliable. For example, but not limited to, able to be folded, tucked, draped and/or otherwise used in a non-rigid form. One exemplary application of some embodiments includes use as a cover for an automotive seat in which the cover may be customized by attaching it to headrests and tucked into the crevice located between the back and bench of the seat, seat and door and/or other locations. This embodiment can be utilized to prevent elements such as dirt or liquids from slipping through the crack. A further application of some embodiments includes attaching it to rear automotive head rests, the removal (only) of the sections required to allow passage of the seat belt and buckle attachments. This exemplary application enables connection of seat belts for use with pet, pet carrier, a child, and/or a child seat. Furthermore, this application reduces the amount of food, drinks, toys, pacifiers, and tiny hands or paws that slip into the crack.

Some embodiments may partly or completely incorporate locations that are not pliable and/or rigid. One embodiment of this arrangement includes a semi-rigid cover cut to fit the rear area of an SUV when the back seats are down, be customized for a truck bed or conform to an automotive trunk. A further embodiment includes a rigid cover, used in conjunction with something that may require a more solid purchase. For example, but not limited to, some embodiment are customized to position a cooler on an irregular area of a boat deck, passenger area and/or cargo hold.

Some embodiments may provide vehicle coverage. Exemplary embodiments may cover golf carts in part or whole to provide illuminative, protective, reflective and/or other properties. Some embodiments allow golfers and other users to cover a vehicle in part or whole and maintain ventilation, visibility and other characteristics required for operation of the vehicle.

Some embodiments may partly or completely incorporate locations configured to be stretchy in an area, along layers, and/or along a surface. An exemplary application of an embodiment configured with a stretchy material for providing a seal around an objects. A further exemplary application of an embodiment includes configuration by cutting an opening for a seat belt buckle. The opening can be made slightly smaller than the buckle, and by pushing the buckle through the embodiment configured with a stretch will create a tighter fit to further help prevent passage of debris or other substances. Embodiments may be constructing from a synthetic fiber, such as, but not limited to, polyester, acrylic, nylon, rayon, acetate and/or PVC the stretch or “give” may be two-way, from selvedge to selvedge, or four-way, such as with Spandex that stretches both crosswise and lengthwise.

Some embodiments may partly or completely incorporate locations that are waterproof, and/or water resistant, on one or both sides. Specific embodiments may incorporate a Waterproofing/water resistance layer, such as but not limited to PVC. Alternatively, layers may incorporate a waterproof coating or water resistant coating, such as but not limited to Scotchguard™ or Teflon™.

Some embodiments may partly or completely incorporate locations that are configured with reinforcement, configured to receive reinforcement, and configured with a finished surface. An exemplary application includes an embodiment configured with reinforcement along seams, and as patches. In contrast, some embodiment may be configured without reinforcement. An exemplary application of this embodiment includes the use of rods and/or laces. Reinforcement(s) may be established during manufacture or pre-sale assembly and/or may be applied and/or employed by end user. An embodiment incorporates reinforced stitching placed near and/or on one or more outside edges. A further embodiment provides this stitching in an interlocking fashion to provide reinforcement in any area that is cut or perforated. In a further embodiment, the stitching form is a ladder design. Application of this arrangement enables a box to be cut with the uncut boxes next to them providing addition support and/or rip stoppage.

Some embodiments may partly or completely incorporate locations that are permanent, semi-permanent, non-permanent or removable customization assistance guides(s), design(s) and/or decoration(s). An embodiment incorporates a grid measured in increments of one inch, or other standard or non-standard measurement. This exemplary arrangement facilitates measuring and customization efforts. A further embodiment incorporates patterns that correspond with items to be covered. Exemplary applications of this arrangement include concentric circles corresponding to a specific deck table sizes, and furthermore corresponding to an area to be cut out (or not) to address the center hole provided for a standard table umbrella. An exemplary application of this embodiment includes its use to protect a table from scratches, debris or other damage. Further embodiment may provide a more pleasant use surface such as a tablecloth. A further embodiment may include an additional starburst imprint radiating from the center for the designation of locations for customization of holes to allow for laces, hooks or other tie-down and/or attachment options.

Some embodiments may partly or completely incorporate locations that are abrasive, course, non-abrasive, smooth and/or all or none of these. An exemplary application of an embodiment with b a non-abrasive surface includes use for preventing the cover from chaffing leather car seats and/or other surfaces. A further exemplary application of an embodiment with an abrasive and/or course surface includes use to prevent Cover and/or items on or otherwise engaged with Cover from slipping and/or an abrasive surface may allow cover to more effectively collect dirt as in, but not limited to, scuffing dirt from shoes to prevent tracking it elsewhere. One embodiment incorporates an abrasive surface such as be jute, nylon and/or polypropylene fibers woven together and sewn into polyester backing, similar to artificial turf construction.

Some embodiments may partly or completely incorporate locations that are used to cover seats, couches, benches and/or other areas of rest such as, but not limited to, car seats, boat seats, chairs, couches.

Some embodiments may partly or completely incorporate locations that are areas which may more easily be removed using techniques, including but not limited, printing, heat scoring, perforation, waffle design, quilted, embossed, stitched. An exemplary application includes an embodiment with the cover configured for heat scoring in one-inch increments to facilitate customization.

Some embodiments may partly or completely incorporate locations that have support(s) for maintaining integrity, strength, or other useful effect. Further embodiments may include decorative supporting structures.

Some embodiments may partly or completely incorporate locations that are shift resistant, slip resistant, and/or skid resistant. An exemplary application includes an embodiment that is resistant to lateral shifting, shifting configuration, preventing objects covered or contained from slipping or shifting. A further exemplary application includes an embodiment for preventing people, animals or items from shifting, slipping and/or skidding. One embodiment contains non-skid treatment in a specific pattern or randomly or covering the full surface. In a further embodiment, structures for providing shift/slip/skid resistance are decorative.

Some embodiments may partly or completely incorporate locations that are slippery through having a very low friction value. An exemplary application includes an embodiment with a Teflon™-coated slick side for facilitating moving one or more object(s) across a surface. One exemplary embodiment allows the cover to be customized to accommodate a heavy or uniquely-shaped object such that it may be more easily moved back and forth, for example move a table away from and/or next to a grill.

Some embodiments may partly or completely incorporate locations that are machine washable. An exemplary application includes embodiments that are configured for a household washing machine, a dry cleaning machine, and/or an industrial laundry.

Some embodiments may partly or completely incorporate locations that are configured to be washable via non-mechanized means. An exemplary application includes an embodiment configured for washing in a sink, bathtub, and/or outdoors with a hose or other non-mechanized means.

Some embodiments may partly or completely incorporate locations that are configured for cleaning with water, other solvents or cleaners such as, but not limited to, ammonia, sand, bleach, etc.

Some embodiments may partly or completely incorporate locations that are configured to be disposable.

Some embodiments may partly or completely incorporate locations that are configured to be biodegradable.

Some embodiments may partly or completely incorporate locations that are configured to kill or substances that may be harmful and/or dangerous to the health of humans and/or animals, including bacteria, germs and other microbes, creatures, and noxious elements. An exemplary application includes an embodiment imbued with natural non-toxic insect repellant, such as Citronella, for use in reducing the number of insects entering, and/or remaining alive in an enclosed space such as a car or hut. A further exemplary application includes use of a customized embodiment in an entry area; this may be especially useful in malarial regions of the world. A further exemplary application includes use of an embodiment incorporating an anti-microbial coating for preventing illness when used in high-traffic areas.

Some embodiments may partly or completely incorporate locations that are configured for attracting or dispensing healthful microbes.

Some embodiments may partly or completely incorporate locations that are configured to be healthful for plants, animals and/or humans. An exemplary application includes an embodiment to protect plants from excessive light or heat.

Some embodiments may partly or completely incorporate locations that are configured to be toxic. For example, but not limited to, use with containing or covering substances that may benefit from and/or require a toxic cover, such as, but not limited to a cover coated with pesticide to reduce and/or prevent insects from breaching a barrier.

Some embodiments may partly or completely configured for use as a promotional item. For example, but not limited to, used as a giveaway with new and/or used cars; gifts for donations to a charity such as, but not limited to, the Humane Society; to promote corporate branding at trade shows; for employee retention gifts; for client rewards, etc.

Some embodiments may partly or completely incorporate locations that are configured to be printable, able to be embossed, or have another type surface or sub-surface and/or relief that can accommodate functional, decorative and/or other design elements and/or information. Exemplary application of embodiments include providing a flat surface for printing; providing a textured image that may contain faux or real fur; holographic and/or images with dimensional depth such as, but not limited to, a design with nostrils having a greater depth than the nose; images that appear to animate and/or change when viewed from different locations.

Some embodiments may partly or completely incorporate locations that are configured for marking with decorative, educational, commercial, non-commercial and/or other design, decoration and/or informational elements. Exemplary applications include embodiments with logos, Biblical passages, promotional images, topical or seasonal images or imprints, licensed designs with companies such as, but not limited to, Disney, Welch's, NFL, Volvo.

Some embodiments may partly or completely incorporate locations that are configured to be written and/or otherwise marked upon. Marks may and/or may not be removable. For example, but not limited to, dry erase, crayons and permanent markers. An exemplary application includes an embodiment with one or more layers comprised of Dry Erase vinyl with guides and/or customization guides to entertain user or allow user to test various configurations before actually customizing embodiment.

Some embodiments may partly or completely incorporate locations that are configured for markings to be erasable, such as but not limited to the ability to have ink, dry erase marker, and/or other writing and/or coloring and/or painting material removed and/or erased from it. An exemplary application includes an embodiment with one or more layers comprised of Dry Erase vinyl with guides and/or customization guides to entertain user or allow user to test various configurations before actually customizing the embodiment.

Some embodiments may be partly or completely compatible with external elements such as reinforcement patches, reinforcement tape, decorative elements, tucking tools, measuring tools, rivets, hook-and-loop fasteners, hook-and-loop pads, hangers, handles, pockets, weights, stabilizers, embellishments, etc.

Some embodiments may be partly or completely scented. An exemplary application includes an embodiment customized for the back seat of a car to scent the car, this may be accomplished by imbuing the material(s) with scent in a similar fashion to other scented materials.

Some embodiments may be partly or completely configured to eliminate and/or diminish odors. An exemplary application includes an embodiment that reduces proximal odors using baking soda. One embodiment comprises two layers of rip-stop nylon filled with baking soda and double-seam heat sealed in 1-inch increments. Double seam allows user to customize embodiment without compromising integrity.

Some embodiments may be partly or completely configured to freshen and/or clean and/or improve the quality of covered, contained or nearby objects or materials. One exemplary application includes an embodiment imbued with baking soda to freshen air. Some embodiments contain, emit and/or are imbued with chlorine or other microbial properties to purify water. In some exemplary embodiments, a water purification cover may allow customization for water pump(s) or other related equipment.

Some embodiments may be partly or completely configured to prevent damage to gasses, liquids or solids. One embodiment may be a waterproof cover to protect items from water damage.

Some embodiments may be partly or completely configured to be absorbent. An exemplary application includes an embodiment configured to wick sweat away from the body similar to those designed for athletes. A further exemplary application includes an embodiment composed/constructed of material(s) similar to those used for incontinence protection pads to absorb liquids but leave a dry outer material.

Some embodiments may be partly or completely configured to have humidity and/or liquid reduction properties. Some embodiments have desiccant properties derived from such substances as, but not limited to, silica, activated charcoal, calcium chloride. For example, this may be converted by end user for specific use in humid environments.

Some embodiments may be partly or completely allow air and/or other gases to pass through, around or under it. For example, but not limited to, a construction and/or design to reduce and/or prevent condensation from forming while a cover rests on a car seat. Waterproof breathable fabrics consist of an outer layer called the “face fabric”, usually made of nylon or polyester, and a laminated membrane or coating, usually made of ePTFE (expanded Polytetrafluoroethylene, also known as Teflon®) or PU (Polyurethane). The purpose of the face fabric is to protect and look stylish; it's not waterproof but is treated with a solution called DWR (Durable Water Repellent) so it doesn't soak up water. The job of keeping the water out is left to the membrane, which has tiny holes too small to let liquid water enter but large enough to allow water vapor to escape. Since contamination with oil, sweat and many chemicals causes PTFE membranes to lose their ability to keep out water, the membrane is protected by an ultra-thin layer of Polyurethane (GORE-TEX® membranes have a bi-component laminate structure) or other oleophobic (oil-hating) treatment (eVent™ does this at the microscopic level with individual PTFE fibers). Finally, a fine scrim or mesh is bonded to the inner surface for comfort in 3 Layer (3L) fabrics. 2 Layer (2L) fabrics receive a separate fabric liner, while 2.5 Layer fabrics use an abbreviated pattern screened on the inner surface to save weight.

Some embodiments may be partly or completely composed of one or more quick-dry material(s). For example, but not limited to, fabrics used for travel, camping and/or athletics.

Some embodiments may be partly or completely composed of one or more lint-free and/or lint reduction and/or reduced lint material(s). For example, but not limited to, microfiber, chamois, leather, vinyl, etc.

Some embodiments may be partly or completely stain proof and/or stain resistant. For example, but not limited to, a material that is coated with stain resistant coating, vinyl, polyurethane, etc.

Some embodiments may be partly or completely configured to be able to be cleaned, with such items as sponge, wipe, and towel.

Some embodiments may be partly or completely pre-customized. An exemplary application includes an embodiment with areas removed for standard use with standard items allowing end user to customize for their specific use. A further exemplary application includes a decorative embodiment with features removed from a facial graphic while leaving the remainder of the cover available for end user customization.

Some embodiments may be partly or completely able to absorb heat. Further embodiments may feel warm to the touch and/or have warming properties. An exemplary application includes an embodiment with electrical conduction elements positioned in areas designated as seat and back portions of an automobile seat. Areas between the two may be designed and designated as customizable for seat belt buckles. A further exemplary application includes an embodiment comprising materials that are the same or similar to materials contained in air activated hand warmers, whereby the embodiment is exposed to air or some other substance or manipulation and becomes warm. For example, but not limited to, this cover may be removed from air-tight packaging and used to warm a flower bed that is around a fountain or other stationary object to keep the flowers from freezing overnight. A further embodiment is configured to enable cutting to adapt to the fountain size and shape and to provide functional areas for poles and or stakes. A further embodiment may be configured to enable campers to remove cover from air-tight package to warm a tent. Another embodiment may be constructed using an insulated wire or heating element inserted into a fabric that transmits heat when it is plugged in. The cover may plug into an automobile, a computer or other equipment using a USB or other connection. A customizable cover containing wires may have a customization guide detailing where it is safe to customize the item without damaging wiring.

A further embodiment may be laced together and/or otherwise customized for specific configurations.

Some embodiments may be partly or completely configured to generate and/or transmit heat. An exemplary application includes an embodiment configured to absorb heat from one source and generate it to another. A further exemplary application includes an embodiment constructed of materials that absorb and retain heat during the day and transmit heat at night. A further exemplary application includes an embodiment configured to be heated by the sun during the day and used to cover items vulnerable to cold temperatures at night. A further embodiment can be configured around plants to warm and/or cool the ground at night. A further exemplary application includes an embodiment configured to cover a specific dog house at night while leaving an opening or flap for the dogs' ingress and egress. Additional customizations may include, but are not limited to perforations for tie-downs.

Some embodiments include pre-customized areas or customization guide(s) to facilitate attachment of additional items to the cover. Some exemplary embodiments include covers with reinforced areas that are identified as areas for attaching non-cover objects. Some exemplary embodiments include an automotive cover with reinforced areas for attaching hooks for supporting hand vacuums and/or attachments for pacifier stabilization and/or pockets and/or pouches to contain other items such as baby wipes.

Some embodiments contain pockets, pouches and/or other areas for containment of cover and/or non-cover items.

Some embodiments are directed toward sporting activities. Some exemplary embodiments serve as a cover or tarpaulin for mountain climbers, hikers, campers or others participating in outdoor activities. Some embodiments are lightweight. Some embodiments allow users to minimize the weight required for the cover's chosen use(s). Some embodiments contain a customization guide(s) for various multiple or singular non-emergency and/or emergency uses. Some embodiments have heat retaining and/or generating properties. Some embodiments have cool/cold retaining and/or generating properties. Some embodiments have illumination properties. Some exemplary uses include protection from the elements that can be customized to a user's specific gear and/or needs. Some exemplary uses include illuminated protection that can enhance a user's night experience, deter animal intrusion, provide assistance for rescue, etc. Some exemplary uses can be customized to cover a user's specific tent/shelter, supplies and/or gear.

Some exemplary embodiments allow runners, road construction workers or others to customize the cover for illuminative, reflective, cooling, heating and/or other properties such that they are able to cover only what they desire and otherwise reduce their level of weight and drag.

Some embodiments may be directed toward indoor activities. Some embodiments may be used customized to fit a certain room or portion of a room such that items, such as quilting, sewing, crafting, toys or other items may be dropped directly onto the cover then bundled when not needed. Some embodiments may be used in a pet grooming area, a kitchen, a mud room or other similar area such that debris can be easily removed.

Some embodiments may be used with domesticated or undomesticated animals. Some embodiments may be used with inanimate objects. Some embodiments may be used with food and/or vegetation.

Some embodiments may be used for pet purposes, such as to serve as a mat or under-mat for indoor pet “potty training” pads or a cat box liner or under-mat for a litter box, as an under-mat or protection for food areas. A further exemplary application includes an embodiment configured to cover a dog house at night while leaving an opening and/or flap for the dog's ingress and egress and to provide ventilation. Additional customizations may include, but are not limited to perforations for tie-downs. A further exemplary application includes an embodiment configured to fit the inside of a dog house. In some exemplary embodiments the cover may absorb and retain the animal's body heat. In some exemplary embodiments the cover may be customized with drainage and/or ventilation holes. In some exemplary embodiments the cover may be easily removed and cleaned.

Some embodiments include use with do-it-yourself (DIY) and/or professional construction. Exemplary embodiments include projects in a room with a column or unevenly designed wall(s). The customization of embodiments enables effective protection of only the necessary area(s) while leaving the work areas exposed. Some embodiments may also incorporate a customization guide for enabling convenient measurement and customization of embodiments to avoid gaps, wrinkles and/or puckers. In some embodiments, the cover is waterproof and/or has a customization guide on the reverse side 308. This customization guide could be a grid in one-inch increments or other design to facilitate precise measurement. Some embodiments are configured as a satisfactorily weighted material, to prevent tearing, or shifting under foot traffic. Some embodiments may have slip-resistant treatment on the underside to provide further stabilization. Some embodiments have a course side or areas to facilitate removal of debris from worker's shoes. Some embodiments can be customized to specific doorways or other openings to prevent the passage of dust, humidity and/or other substances or elements. Some embodiments provide insulating properties. Some embodiments can be customized to cover machinery, equipment, materials and/or other objects and/or areas.

Some embodiments may be partly or completely configured to reflect heat and/or light. One embodiment may comprise of polyester fabric layer connected to and/or coated with reflective stretched polyester film (e.g., Mylar). One embodiment may have the film and polyester fabric layers sewn together in a pattern that forms a customization grid. An exemplary application includes an embodiment constructed of materials that reflect heat from the sun during the day. In this arrangement, the embodiment reflects heat and can be cut to cover a dog house during the day while allowing the user to create an opening or flap for the dog's ingress and egress and ventilation. Additional user customizations may include, but are not limited to perforations for tie-downs.

Some embodiments may be partly or completely cool. An exemplary application includes an embodiment able to be treated or manipulated such as, but not limited to, freezing with ice or other refrigeration methods to cool whatever is covered, contained or otherwise affected. The embodiment may be composed of two sides vinyl partially or fully filled with water or some other substance and double seam heat sealed in increments forming a customization guide. Double seam allows user to customize without compromising integrity. Embodiment could then be chilled or frozen. Some embodiments may have customization guide(s) provided in ways other than double-seam heat sealed.

Some embodiments may be partly or completely configured to be heat resistant. An exemplary application includes an embodiment configured to resist heating and/or overheating when exposed to sunlight. A further exemplary application includes an embodiment configured to resist melting when exposed to heat.

Some embodiments may be partly or completely configured to be flame resistant and/or flame retardant. An exemplary application includes an embodiment configured to resist flames in an automobile accident. An exemplary application includes an embodiment composed of mineral wool, which can withstand heat in excess of 1,800 degrees F.

Some embodiments may be partly or completely configured to transmit and/or absorb and/or be penetrated by radiation. An exemplary application includes an embodiment configured to absorb solar radiation to generate or maintain warmth. An exemplary application includes an embodiment with three layers: silver foil insulation sandwiched between black vinyl and black neoprene. The layers are fused together and printed in white with a customization grid. When exposed to sunlight/UV radiation, the embodiment absorbs and retains heat. Exemplary embodiments may be cut to fit a garden or crop such that the plants are exposed while the ground is covered and remains warmer at night. The cover may be water permeable to allow plants/crops to be hydrated and/or fertilized and/or otherwise affected.

Some embodiments may not transmit and/or may repel and/or may reflect radiation. An exemplary application includes an embodiment configured to shield certain areas of a garden or field from solar radiation, while leaving other areas exposed. This would be especially useful for a user with a garden or field containing bright sun and shade-loving plants interspersed in non-contiguous areas. The embodiment may be situated such that the sun lovers receive full sun via areas that have been completely removed, while the shade plants may be under an area that has been customized with piercings to provide dappled sun An exemplary application includes an embodiment configured to provide a customized cover for dental patients receiving x-rays and/or for equipment that may be damaged by radiation. This may be especially useful for larger patients who may not be completely covered by today's standard covers. One embodiment to reflect solar or other radiation may consist of polyester fabric attached to and/or coated with reflective stretched polyester film (e.g., Mylar). One embodiment may have the film and polyester fabric sewn or fused together in a pattern that forms a customization grid. Exemplary embodiments may provide expanded or more appropriate coverage from x-rays for dental, medical or other living beings.

Some embodiments may be used with or without other covers.

Some embodiments may be partly or completely configured to be cold and/or freeze resistant. An exemplary application includes an embodiment constructed of material that retain heat similar to, but not limited to, the Mylar covers given to marathon runners at the end of a race. One embodiment configured for retaining heat may comprise a polyester fabric attached to and/or coated with reflective stretched polyester film (e.g., Mylar). One embodiment may have the film and polyester fabric sewn together in a pattern that forms a customization grid. Such covers may be customized to, for example, but not limited to, cover specific garden areas during a frost, especially those in awkward locations. A further embodiment can be customized for, but not limited to, tie-downs, stakes, container irregularities, etc. Exemplary embodiments may lie on the ground and be customized to provide openings for plants, these embodiments prevent plant roots from being damaged by cold or frost.

Some embodiments may be partly or completely configured to have anti-static and/or non-static properties. An exemplary application includes an embodiment used to cover or contain animate or inanimate bodies in areas where ESD (electrostatic discharge) can damage sensitive equipment. One application includes an embodiment comprised of silicone coated fiberglass fabric and/or cotton fireproof non-static fabric. Exemplary embodiments may be used by researchers to cover and/or protect items in development.

Some embodiments may be partly or completely cushioned, padded, and/or shock absorbent. An exemplary application includes an embodiment cushioned to provide additional comfort when used as a car seat cover. Another embodiment has multiple layers: vinyl, open-cell flexible polyurethane foam, cotton batting and rip-stop nylon. Embodiments may be constructed of and/or contain other materials with cushioning, padding and/or shock absorbent properties. Embodiments may be constructed of and/or contain other materials with cushioning, padding and/or shock absorbent properties.

Some embodiments may be partly or completely lighted. An exemplary application includes an embodiment configured to comprise LED, chemical, and/or other lights or elements with luminous properties for decorative, illuminative, heat generation and/or other purposes. An exemplary application includes an embodiment configured to glow through the process of chemiluminescence, as with a glow stick. The clear vinyl embodiment is comprised of two sides. One side of the cover contains multiple plastic ampoules filled with Phenyl oxalate and fluorescent dye solution sealed into pouches with Hydrogen peroxide solution. The pouches are distributed at intervals across the surface of Side 1 and glued into place. Side 2 is placed over the ampoule pouches and secured to Side 2 using a wide-weal heat press signature to create a waterproof seal. Each segmented pressed area surrounds one pouch. The heat press weal is wide enough to allow user to configure embodiment without compromising structural integrity. User crushes ampoules to illuminate. Some embodiments allow customization with perforated areas that can be punched out or otherwise removed by capsized boating passenger(s), such that they can be completely surrounded by the cover and kept afloat and visible to search-and-rescue teams.

Some embodiments include optic fiber. Some embodiments include optic fiber in conjunction with LED light(s). Embodiments may be constructed with optic fibers distributed throughout the cover and illuminated by one or more LED lights. Some exemplary embodiments may be used to illuminate people, locations and/or lost objects to assist search-and-rescue teams in locating them.

Some embodiments provide heating and/or cooling and/or illumination properties customized for boating or other water-related activities. Some embodiments can be customized to provide warmth while still allowing free movement of body parts required to steer or otherwise affect the use or movement of watercraft such as a lifeboat.

Some embodiments can be designed such that a one-size-fits all product can be custom tailored to comfortably fit a specific user. Some embodiments can be customized to provide specific coverage that can be tailored by the user to fit very large people, as well as small children and/or pets. Exemplary embodiments may be items that provide heat, cool, reflective, illuminative and/or properties and distributed to disaster relief victims. Exemplary embodiments could be customized by users by removing perforated portions to form make-shift clothing, covers, containers or other useful objects.

Some embodiments may be partly or completely configured to be phosphorescent or otherwise glow-in-the-dark, and/or have reflective or absorptive materials, components or surfaces. One or more layers of the embodiment would have a phosphor coating that is energized by normal light and that has a very long persistence. Two phosphors that have these properties are Zinc Sulfide and Strontium Aluminate.

Some embodiments may be partly or completely designed for use with UV light or other special lighting, reflective, absorptive materials, components or surfaces. An exemplary embodiment can be customized by removing a protective layer in selected locations and exposing those areas to sunlight which then immolates the exposed area. One embodiment has a cover with a printed or otherwise incorporated design composed of phosphors.

Some embodiments may be partly or completely configured to produce, provide, be covered and/or coated with, be detected by, reflect and/or absorb infrared radiation and/or the infrared region of the light spectrum. An exemplary application includes an embodiment having properties that may be detected and/or viewed in low and/or no light by employment of special technology. Another exemplary application is an embodiment that reduces the conductive temperature of an item below it, whereby the Cover is created to contain insulating material to reduce the heat signature of the covered item. The embodiment has multiple layers: vinyl, open-cell flexible polyurethane foam, cotton batting and rip-stop nylon. The embodiment contains customization guide with discreet segments spanning the Cover surface. This double-seam construction allows user to customize cover by cutting through one seam while leaving the other seam in-tact to maintain structural integrity. Some exemplary embodiments allow military users to customize to reduce detection of warm items/areas while allowing ventilation or exposure to items or areas with no heat signature or creating a heat signature that is visible but designed to camouflage or deceive. Such use may be especially valuable when troops are in the field and addressing uniquely formed and/or changing objects or areas.

Some embodiments may be partly or completely configured produce, provide, be covered with, be detected by, reflect and/or absorb ultraviolet (UV) radiation and/or the ultraviolet (UV) region of the light spectrum. An exemplary application includes an embodiment degrade under ultraviolet (UV) light. One embodiment has a cover with a printed or otherwise incorporated design composed of phosphors.

Some embodiments may be partly or completely clear, transparent, translucent and/or opaque.

Some embodiments may float. One embodiment may be vinyl on both sides and be filled with air in one-inch heat-press sealed squares. Width of wells would allow customization without compromising buoyancy.

Some embodiments may be partly or completely configured to be reflective. One embodiment to retain heat may consist of polyester fabric attached to and/or coated with reflective stretched polyester film (e.g., Mylar). One embodiment may have the film and polyester fabric sewn together in a pattern that forms a customization grid.

Some embodiments may be partly or completely incorporate properties that are purported or proven to alter emotion. An exemplary application includes embodiments that emit scents that are calming, energizing, enhance concentration, etc. An exemplary application includes an embodiment that is imbued with fragrance microcapsules embedded in the fabric that is proven or purported to affect emotion such as, but not limited to, lavender for calming, lemon for energizing. (Ref. Fragrance microcapsules for fabric conditioning U.S. Pat. No. 5,246,603 A)

Some embodiments may be partly or completely have magnetic properties in all or a portion of the item. Further embodiments may contain magnet(s) attached to and/or embedded into the item. An exemplary application includes an embodiment configured with embedded magnets to allow it to more easily affix to metal objects. A further exemplary application includes an embodiment for providing magnet therapy for actual and/or purported health benefits. In this specific application, an embodiment may be customized for the back seat of an automobile and provide magnet therapy for the back seat passengers and/or may be customized to fit a lounge chair.

Some embodiments may be partly or completely therapeutic. An exemplary application includes an embodiment configured with, gel, foam, aromatherapy, magnets. A further exemplary application includes an embodiment customized for the back seat of an automobile and providing more comfort and/or stress relief on pressure points for the back seat passengers.

A further exemplary application includes an embodiment customized for fitting and attaching to a recliner, and further customized to provide more comfort and/or pressure point relief for user(s). In this arrangement, the embodiment may be customized to allow access to recliner controls.

Some embodiments may be partly or completely comprise weights, other stabilizers, and/or similar features.

Some embodiments may be partly or completely configured to be cleaned and/or otherwise affected using a vacuum and/or suction device. An exemplary application includes an embodiment customized for the back seat of an automobile, and further customized to allow attachments for a child seat and a hand vacuum could be used to remove cereal, chips or any other debris and/or liquids and/or objects.

Some embodiments may be partly or completely configured to be used with fasteners, other accessories, and/or decorations. An exemplary application includes an embodiment with pre-printed customization guides to indicate where to place incisions for optimal fastener attachment to cover a specific make and model of car seat.

Some embodiments may be partly or completely configured to levitate, and/or float. An exemplary application includes an embodiment with a multi-layer airtight body composed of two layers of vinyl and sealed on all sides. The body is then injection infused to ¾ capacity with helium, air or other effective gas. The injector is removed and the injection point is heat sealed. Then, the body is heat pressed with double seams to create multiple discreet airtight chambers to allow for customization by cutting between the double seams without damaging the levitation/buoyancy properties of the object. Double seams allow customization without compromising functionality. Some embodiments may be customized such that portions can be removed to form letters, words and/or graphics for floating advertising signs.

Some embodiments may be partly or completely configured to comprise one or more sensor(s). An exemplary application includes an embodiment comprising biosensors to detect, monitor and/or report physiological information of being(s) in contact with the embodiment. (Ref. System for monitoring health, wellness and fitness U.S. Pat. No. 6,605,038 B1) One embodiment may include an infrared skin thermometer inserted into a thin vinyl pouch attached to the cover to detect the temperature of a body sitting or lying on the thermometer, this embodiment may also be customized to be used with a child restraint seat. Infrared skin thermometers (currently sold by Braun and others) measure the heat produced by the skin.

Some embodiments may partly or completely incorporate locations that are configured with thermochromatic properties. An exemplary embodiment includes thermochromatic paint on an exterior surface. A further exemplary application includes an embodiment for viewing the temperature of an animate or inanimate body. A further exemplary application includes an embodiment for entertaining children and configured for fitting the back seat of an automobile.

What has been described and illustrated herein is an embodiment of the disclosure along with some of its variations. The terms, descriptions and figures used herein are set forth by way of illustration only and are not meant as limitations. Those skilled in the art will recognize that many variations are possible within the spirit and scope of the disclosure in which all terms are meant in their broadest, reasonable sense unless otherwise indicated. Any headings utilized within the description are for convenience only and have no legal or limiting effect.

While the disclosed subject matter has been described with respect to a limited number of embodiments, the specific features of one embodiment should not be attributed to other embodiments of the disclosed subject matter. No single embodiment is representative of all aspects of the disclosed subject matter. Moreover, variations and modifications therefrom exist. For example, the disclosed subject matter described herein may comprise other components. Various additives may also be used to further enhance one or more properties. In some embodiments, the disclosed subject matter is substantially free of any additive not specifically enumerated herein. Some embodiments of the disclosed subject matter described herein consist of or consist essentially of the enumerated components. In addition, some embodiments of the methods described herein consist of or consist essentially of the enumerated steps. The claims to be appended later intend to cover all such variations and modifications as falling within the scope of the disclosed subject matter.

What is claimed is:

1. A customizable multi-use cover comprising:
a protective cover having a front, back and upwardly and facingly disposed sides;
the cover comprising one or more pliable layers comprised of a pliable material;
whereby portions of the sides are removed to adapt and conform the cover to fit over an object;
whereby first openings are cut through the cover to removably attach the cover to a vehicle headrest; and
whereby second openings are cut through the cover to accommodate a seat belt buckle.

2. The customizable multi-use cover of claim 1 wherein the object is selected from the group consisting of automobiles, boats, recreational vehicles, all-terrain vehicles, lawn mowers and mechanical equipment.

3. The customizable multi-use cover of claim 1 wherein the upwardly and facingly disposed sides further comprise a customization guide to provide an end user with guidance on customizing the cover to fit the object.

4. The customizable multi-use cover of claim 1 wherein the pliable material comprises a material that is resistant to tearing, puncturing, injury and destruction.

5. The customizable multi-use cover of claim 1 wherein the pliable material is waterproof.

6. The customizable multi-use cover of claim 1 wherein at least one of the sides is formed from a material with non-slip properties.

7. The customizable multi-use cover of claim 1 wherein the cover is customizable by an end user.

8. A kit comprising:
a customizable protective cover having a front, back and upwardly and facingly disposed sides;
the cover comprising one or more pliable layers comprised of a pliable material;
whereby portions of the sides are able to be removed by an end user to adapt and conform the cover to fit over an object;
whereby first openings are able to be cut through the cover to removably attach the cover to a vehicle headrest; and
whereby second openings are able to be cut through the cover accommodate a seat belt buckle.

9. A method of customizing a vehicle seat cover by an end user comprising the steps of:
taking a protective cover having a front, back and upwardly and facingly disposed sides,
the cover comprising one or more pliable layers comprised of a pliable material;
customizing the cover by removing portions of the sides to removably adapt and conform the cover to fit a vehicle seat;
customizing the cover by cutting first openings through the cover to removably attach the cover to vehicle headrests; and
customizing the cover by cutting second openings through the cover to accommodate a seat belt restraints.

10. A customizable multi-use cover comprising:
a protective cover having a front, back and upwardly and facingly disposed sides;
the cover comprising one or more pliable layers comprised of a pliable material;
wherein the cover is configured such that portions of the sides may be removed by an end user to adapt and conform the cover to fit over an object;
wherein the cover may be removably attached to the object; and
wherein openings through the cover to accommodate a seat belt buckle.

11. The customizable cover of claim 10 wherein the object is a vehicle and the cover is removably attached to a vehicle headrest through openings in the cover.

12. The customizable cover of claim 11 further comprising second openings through the cover to accommodate a seat belt buckle.

13. The customizable multi-use cover of claim 1 further comprising a customization guide attached to one of the sides of the protective cover.

14. A customizable multi-use cover comprising:
a protective cover having a front, back and upwardly and facingly disposed sides;
the cover comprising one or more pliable layers comprised of a pliable material; and
whereby portions of the sides are removed to adapt and conform the cover to fit over an object.

15. The customizable multi-use cover of claim 14 whereby openings are cut through the protective cover to removably adapt the cover to the object.

16. The customizable multi-use cover of claim 14 further comprising a customization guide attached to one of the sides of the protective cover.

17. A method of customizing a vehicle seat cover by an end user comprising the steps of:
taking a protective cover having a front, back and upwardly and facingly disposed sides,
the cover comprising one or more pliable layers comprised of a pliable material;
customizing the cover by removing portions of the sides to removably adapt and conform the cover to fit an object; and
customizing the cover by cutting openings through the cover to removably attach the cover to the object.

18. The method of claim 17 further comprising a customization guide attached to one of the sides of the protective cover.

19. The customizable multi-use cover of claim 1 wherein the pliable material is water resistant.

20. The kit of claim 8 wherein the pliable material is water resistant.

21. The customizable multi-use cover of claim 10 wherein the pliable material is water resistant.

22. The customizable multi-use cover of claim 14 wherein the pliable material is water resistant.

23. The method of claim 17 wherein the pliable material is water resistant.
